(19) United States
(12) Patent Application Publication
(10) Pub. No.: US 2005/0050184 A1
(43) Pub. Date: Mar. 3, 2005

(54) Method, system, and storage medium for providing life-cycle management of grid services

(75) Inventors: Edward B. Boden, Highland, NY (US); Michael D. Williams, Newark Valley, NY (US)

Correspondence Address: Philmore H. Colburn II;CANTOR COLBURN LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/652,152

(22) Filed: Aug. 29, 2003

(51) Int. Cl. G06F 15/173

(52) U.S. Cl. 709/223

(57) ABSTRACT

An exemplary embodiment of the invention relates to a a method, system, and storage medium for providing life-cycle management of grid services. The system comprises at least one OGSI-enabled hosting environment in communication with a grid client system via a communications network. The system further comprises a grid services management system executing on the OGSI-enabled hosting environment. The grid services management system includes a service state and transition model that defines life-cycle service states and transition states associated with a grid service.

### BACKGROUND

The present invention relates generally to web services, and more particularly, the invention relates to a system for providing life-cycle management of grid services.

Web services include independently operated applications that are implemented over the Internet and which allow disparate systems to interact via common specifications and protocols. Existing Web services are still in their infancy stage. To date, there is no universally-accepted standard that would allow business enterprises to realize the full potential of Web services. One type of Web service that is breaking ground is grid computing which involves bringing together numbers of heterogeneous computing devices resulting in a virtual organization (VO) whereby processing cycles and other resources can be shared for implementing complex functions.

The Open Grid Services Architecture (OGSA) is a grid system architecture based on an integration of Grid and Web services concepts and technologies. It includes a community-based set of services and software libraries for providing security, information infrastructure, resource management, data management, communication, fault detection, and portability functions. OGSA utilizes Web Services Description Language (WSDL), an XML-formatted language, to describe a Web service's capabilities for exchanging messages. OGSA includes WSDL interfaces, conventions, and service bindings that define the components required for creating complex distributed systems, such as lifetime management and notification, as well as for supporting security features. Utilizing WSDL, the OGSA architecture defines extensions to web services that specify properties for grid applications. These extensions, and their definitions in the OGSA specification, seek to provide a standard for technology such as portType relationships and service data in order to ensure interoperability among running grid services.

Grid services are currently being defined by an open-standards process created by the Global Grid Forum (GGF), as part of OGSA. The standards defined by the GGF are outlined in the “Grid Service Specification” (Open Grid Service Infrastructure, or OGSI, Specification). The Grid Service Specification defines architectural and client interface aspects of grid services, but does not address many implementation specifics. For example, many details concerning how to provide grid services in a hosting environment such as Java 2 Enterprise Edition (J2EE)™ are not provided. The J2EE environment is amenable to the utilization of grid services due to its open standards nature.

What is needed, therefore, is a way to manage grid service life-cycles, in a variety of hosting environments, while maintaining compatibility and compliance with the OGSI specification.

### SUMMARY

An exemplary embodiment of the invention relates to a method, system, and storage medium for providing life-cycle management of grid services. The system comprises at least one OGSI-enabled hosting environment in communication with a grid client system via a communications network. The system further comprises a grid services management system executing on the OGSI-enabled hosting environment. The grid services management system includes a service state and transition model that defines life-cycle service states and transition states associated with a grid service.

### BRIEF DESCRIPTION OF THE DRAWINGS

Referring now to the drawings wherein like elements are numbered alike in the several FIGURES:

FIG. 1 is a block diagram of a system upon which the grid services management system is implemented in an exemplary embodiment;

FIG. 2 is a grid service state and transition diagram defined by the grid services management system for managing a grid service life-cycle; and

FIG. 3 is a diagram illustrating ServiceData enhancements to accommodate life-cycle management via the grid services management system in an exemplary embodiment.

### DETAILED DESCRIPTION OF A PREFERRED EMBODIMENT

The grid services management system defines the stages in a grid service life-cycle and maps those stages to the grid service specification architectural elements, and to a hosting environment. The transitions between the stages are defined and trigger events are defined. The grid services management system allows for dynamic deployment and undeployment of grid services, grid service self-undeployment capability, clear separation of responsibility for grid service life-cycle for simplifying grid service development, callable interfaces for life-cycle state transitions, among other advantages.

OGSA defines the semantics of a Grid service instance: how it is created and named, has its lifetime determined and communication protocols selected. OGSA does not place requirements on what a service does or how it performs that service. OGSA does not address issues such as the implementation programming model, programming language, implementation tools, or execution environment. A specific execution or hosting environment instantiates Grid services. A hosting environment defines not only the implementation programming model, programming language, development tools, and debugging tools, but also how a Grid service implementation meets it obligations with respect to Grid service semantics. Container- or component-based hosting environments such as J2EE, Websphere, NET, and Sun ONE can implement Web services such as a grid service and offer superior programmability, manageability, flexibility, and safety. A container has primary responsibility for ensuring that the services it supports adhere to Grid service semantics and for offloading some service responsibilities from the service implementer.

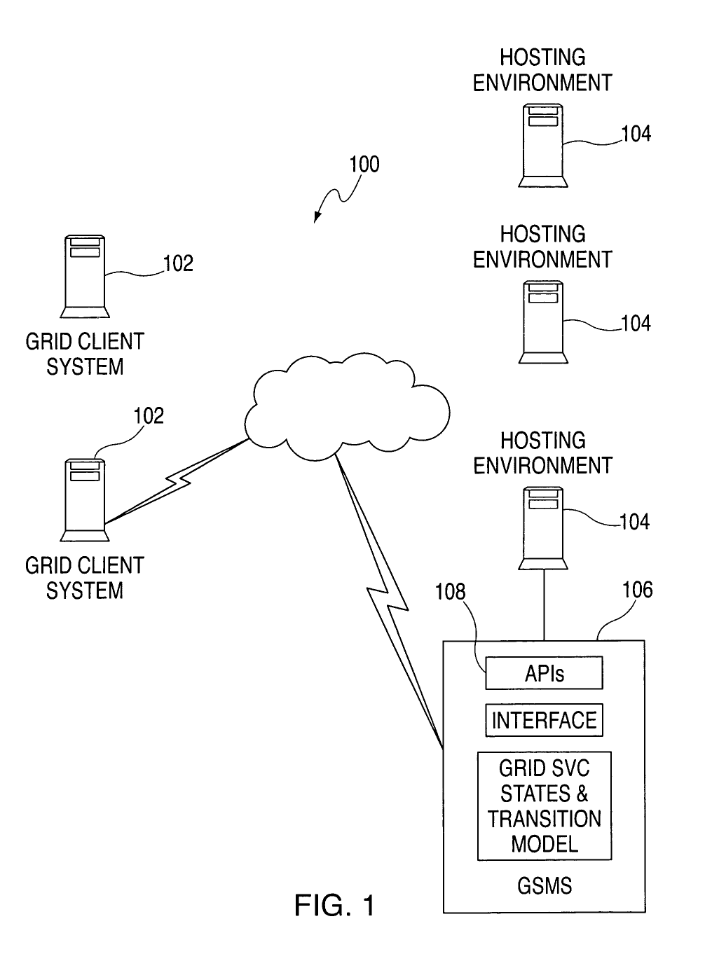

The grid services management system is implemented via a network system such as that depicted in FIG. 1. FIG. 1 illustrates a network system 100 and includes grid client systems 102. Grid client systems 102 refer to computer devices that request grid services and may comprise any suitable web-enabled processing devices. Grid hosting environments 104 refer to systems that provide grid services to client systems. Grid hosting environments 104 are OGSI-compliant and may comprise any suitable Internet software platform for building web-based and e-business applications such as IBM's Websphere™, Sun Microsystem's Open Net Environment (Sun ONE)™, or Microsoft's .NET™ platform. Grid client systems 102 and hosting environment systems 104 are in communication via a network connection such as the Internet. The grid services management system 106 application may be executed by hosting environments 104 and comprises APIs 108 and grid service state and transition model 110 as described further herein.

The basic actions associated with grid services are deploy (undeploy), start (stop), and register (unregister). The registered and unregistered states refer to the service being added and removed to a registry service that implements the service group portType as defined in the OGSI specification. A grid service must be deployed before started, and started before it can be registered. The only exception is built-in grid services which may not be undeployed stopped, or unregistered. The following table shows allowed states and transitions allowed for a grid service in an OGSA hosting environment.

| From | | | | | | | | | |
|---|---|---|---|---|---|---|---|---|---|
| V | to-> | 000 | 100 | 110 | 111 | 011 | 010 | 101 | 001 |
| 000 | | . | y | — | — | — | y | err | err |
| 100 | | y | . | y | — | — | — | err | err |
| 110 | | — | y | . | y | y | y | err | err |
| 111 | | — | — | — | y | . | y | err | err |
| 010 | | y | — | y | — | y | . | err | err |
| 101 | | err | err | err | err | err | err | . | err |
| 001 | | err | err | err | err | err | err | err | . |
| | To-> | 000 | 100 | 110 | 111 | 011 | 010 | 101 | 001 |

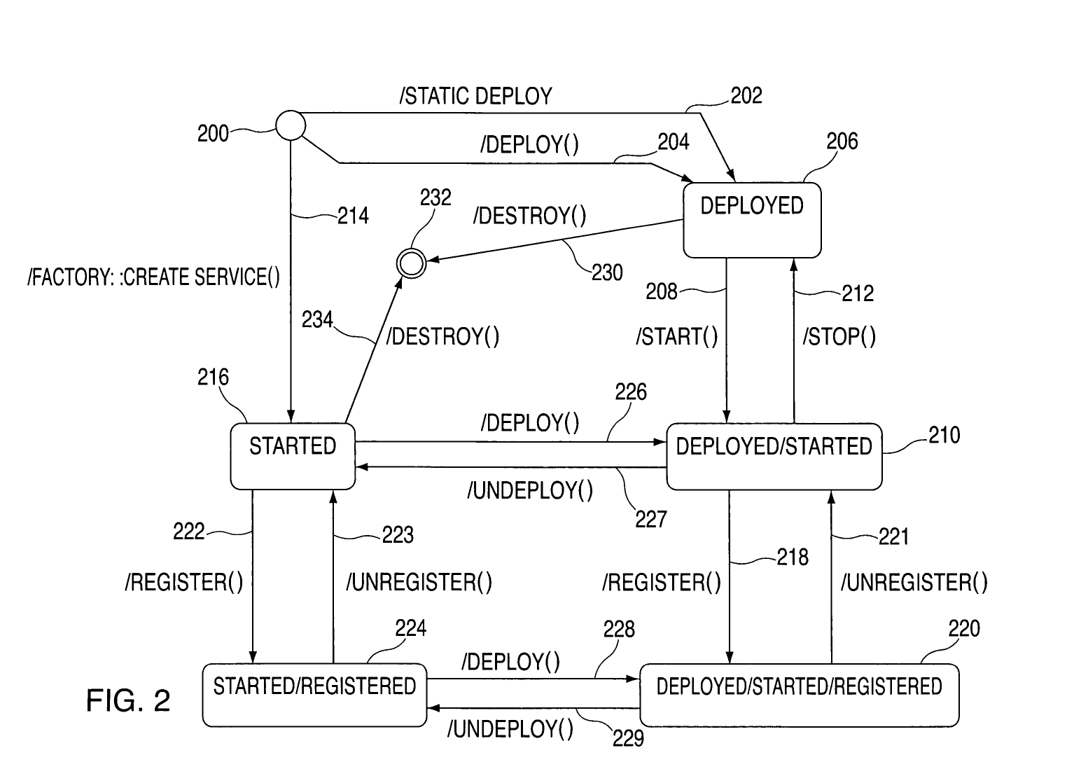

The bit encoding for the grid service actions shown above are: 111={deployed, started, registered} to 000={undeployed, stopped, unregistered}. The ‘y’ notation indicates that a transition is allowed. The ‘-’ notation indicates that a transition is not allowed. A‘.’ indicates that a transition is allowed and is a ‘no-op’, or ‘no operation’, indicating that no transition is performed. A state labeled ‘err’ should not occur, as there is no allowed transition to that state. The grid service state and transition model 110 is illustrated in the diagram of FIG. 2.

The basic concepts and actions for each of the state transitions are shown in FIG. 1. The blocks represent service states, the arrows represent service state transitions, and the dots represent a ‘start’ and ‘termination’ point of the service.

The ‘/static deploy’ transition 202 indicates the initiation of a static grid service deployment. The ‘/deploy( )’ transition 204 indicates the initiation of a dynamic grid service deployment. If the deployment is static 202, the grid service will be automatically started at the next OGSI-instance (re)start. When deployment is dynamic 204, the grid service is automatically started immediately after deployment. A grid service handle (GSH) is assigned during transition 202, 204 for both static and dynamic grid service deployments. The deployed block 206 represents the deployed service state. A grid service handle is an element of the OGSI architecture and refers to a unique identifier assigned to each grid service instance in order to differentiate one from another.

The ‘/start( )’ transition 208 between deployed service state 206 and deployed/started service state 210 indicates that the grid service has become operational. A grid service reference (GSR) is generated during deployed/started service state 210 and the associated HandleMap is updated. A GSR is an element of the OGSI architecture and incorporates instance-specific information required to interact with a specific service instance. A GSR can change over a service's lifetime, unlike a GSH which remains static. The ‘/stop’ transition 212 between deployed/started service state 210 and deployed service state 206 refers to a state where a deployed grid service stops operating. The associated GSR is unallocated and removed from the HandleMap during transition 212 and the GSH is persisted.

The ‘/factory::createService( )’ transition 214 between an initiation point 200 and ‘started’ service state 216 refers to the point where the grid service becomes operational. The GSH and GSR are generated and assigned during transition 214, and other preparations are made (e.g., the HandleMap is updated) to ready the grid service and the OGSI-instance and its hosting environment so that messages destined for the grid service are delivered correctly. This typically occurs when a grid service factory responds to a createService grid service operation.

The ‘/register( )’ transition 218 between deployed/started service state 210 and deployed/started/registered service state 220 indicates that the grid service is registered in the local OGSI-instance registry. A registered grid service can be unregistered as defined by ‘/unregister( )’ transition 221. The grid service can continue to operate normally even if unregistered. Note, however, that a grid service that is not running cannot be registered, so for a registered grid service to be destroyed, it must be unregistered and stopped before it can be undeployed.

The ‘/register( )’ transition 222 and ‘/unregister( )’ transition 223, located between ‘started’ service state 216 and started/registered service state 224, is similar to the ‘/register( )’ transition 218 above and will not be further described.

The ‘/deploy( )’ transition 226 between ‘started’ service state 216 and deployed/started service state 210 occurs when a running grid service instance determines that it should be deployed (e.g., have a persistent GSH, and be started automatically upon OGSI-instance (re)start), in which case it invokes a OGSI-instance method. ‘/undeploy( )’ transition 227 refers to the transition that occurs when a deployed grid service is undeployed.

The ‘/deploy( )’ transition 228 and ‘/undeploy’ transition 229 between started/registered service state 224 and deployed/started/registered service state 220 is similar to transition 226 above and will not be further described.

The ‘/destroy( )’ transition 230 between deployed service state 206 and terminal point 232 refers to a transition where a deployed grid service is destroyed. Its GSH is unallocated and the grid service will not be started on the next OGSI-instance (re)start. There is no GSR. The destroy operation may be initiated either explicitly as a result of the destroy operation on the service or by softstate destruction.

The ‘/destroy( )’ transition 234 between ‘started’ service state 216 and terminal point 232 indicates that the operational grid service instance is destroyed, the GSH and GSR are unallocated, and HandleMap and GSR are updated.

The grid service hosting environment for the grid services management system is the OGSI. A running instance of OSGI on a server such as grid hosting environment 104 provides the grid service's runtime and developer's programming environment. Given a defined life-cycle model, the packaging of the programming interface for grid service developer's to support that model can be represented as a Java interface. An example of a life-cycle interface 108 is shown below.

/**
* An OGSI interface to provide a grid service access to built-in life-cycle
functions.
*
* @version %I%, %G%
* @since OGSA rel. 1
*/
//-------------------------------------------------------------------------------------
Public interface GridServiceLifeCycle {

/**
* Basic getters ...
*/
LifeCycleSDE get_gridServiceLifeCycle( );
Date get_gridserviceLifeCycleTime( );
/**
* Provide a few simple ways to self-transition your state. Note that

some transitions * are not allowed and some are not allowed to be
done by the grid service, to itself.

* (aka setters....)
*/
Void set_gridServiceLifeCycle( LifeCycleSDE lifecycle )
Throws OgsiSDEvalueException, OgsiParamException;
Void set_gridServiceLifeCycleDeployed( );
Void set_gridServiceLifeCycleUndeployed( );
Void set_gridServiceLifeCycleRegistered( GSH registryGSH );
Void set_gridServiceLifeCycleUnregistered( );
} // GridServiceLifeCycle

The grid services management system also provides an interface 108 that allows the grid service to be notified of any state transition that is being imposed upon the service by the hosting environment. In addition to the state transition, the service is also passed the state it is being transitioned from in the call. A sample of how this interface may be defined is shown below.

/**
* An OGSI interface that a grid service must implement to be notified
of its state
* transitions. When the grid service is notified via one of the defined
callbacks, the
* previous state is also given to the service.
* @version %I%, %G%
* @since OGSA rel. 1
*/
//--------------------------------------------------------------------------------------
Public interface GridServiceLifeCycleCallback {

Void deployed( LifeCycleSDE previousState );
Void undeployed( LifeycleSDE previousState );
Void started( LifeCycleSDE previousState );
Void stopped( LifecycleSDE previousState );
Void destroyed( LifeCycleSDE previousState );
Void registered( LifeCycleSDE previousState );
Void unregistered( LifecycleSDE previousState );
} // GridServiceLifeCycleCallback

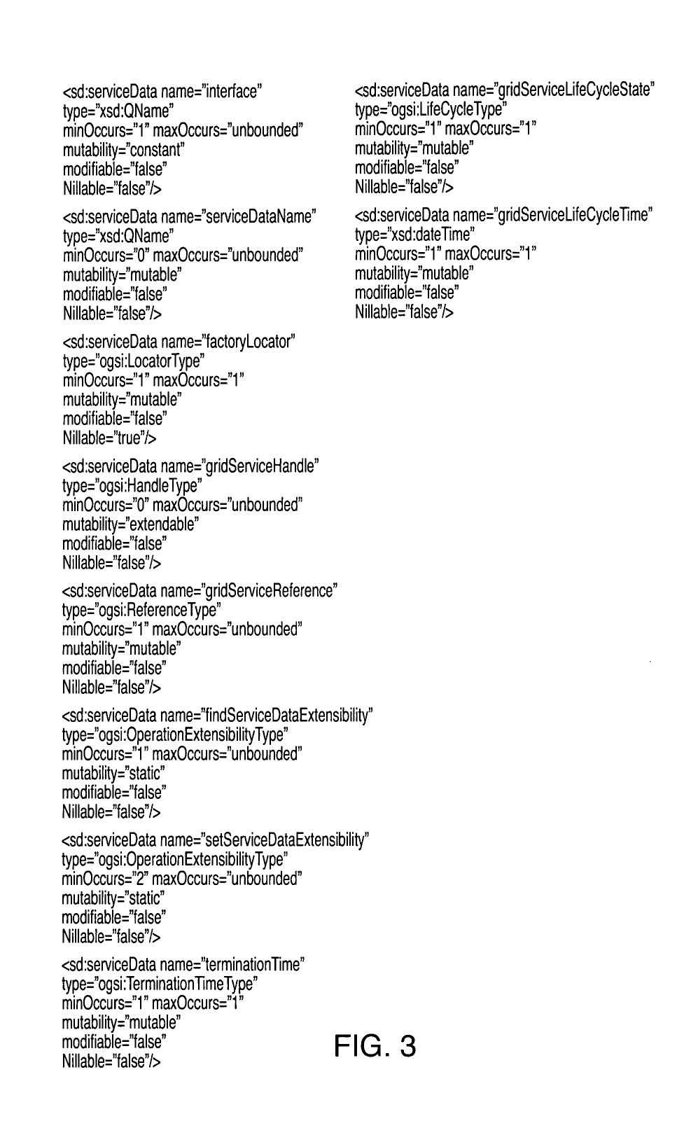

The Grid Services Specification defines a standard set of serviceData associated with each grid service. The Grid Services Specification supports extensibility in many ways, which is one reason it supports XML. An example of XML extensions for the grid services management system lifecycle is illustrated in FIG. 3. The XML example of FIG. 3 shows how the GridService portType serviceData can be extended to support the lifecycle management system of the grid services management system. The initial SDEs, through terminationTime, are from the Grid Services Specification.

The gridServiceLifeCycleState SDE would have one of the value of the new defined type ogsi:LifeCycleType as shown in the XSD schema below, with values based on the state names: {deployed, deployedStarted, Started startedRegistered, deployedStartedRegistered}. When required, the value would be obtained by the grid service via the API interface class shown above.

<xds:schema targetNamespace=“http://ogsi.grid.name.com/
2003/02/LifeCycle”>

<xsd:simpleType name=”LifeCycleType”>

<xsd:restriction base=”xsd:token”>

<xsd:enumeration value=”deployed”/>
>xsd:enumeration value-”deployedStarted”/>
<xsd:enumeration value=”started”/>
<xsd:enumeration value=”StartedRegistered”/>
<xsd:enumeration value=”deployedStartedRegistered”/>

</xsd:restriction>

<xsd:simpleType>

</xds:schema>

The gridServiceLifeCycleTime indicates the date and time, as a standard XSD type, that the state indicated by gridServiceLifeCycleState, was achieved. Again, when required, this value would be maintained by OGSI for the grid service, and retrieved via the above API interface.

As mentioned above, a well-defined grid service state machine allows for grid services to be easily mapped to other component models such as J2EE. This makes it possible to more easily expose these components as services as described in the OGSA architecture. As implied in the name, J2EE Environment EJBs are stateful components or entities that have a specified life-cycle. The EJB entity specification also defines a client interface that allows the bean's life-cycle to be controlled. For example, the client is able to create and remove an entity. The grid service state model of the grid services management system and hosting environment allows a very simple service skeleton to be implemented that simply delegates to an existing Entity bean. In this case, not only are the services operations delegating to the Entity's “business” logic or methods, but also the service's state.

Specifically, when notified of key lifecycle change events (state transitions) via the callback interface described above, the service can delegate to the underlying Entity bean implementation via the Entity's client interface. The transitions that could be mapped are: grid service createService to EJB create, grid service destroy to EJB remove, and grid service start to EJB find.

By defining the stages in a grid service life-cycle and mapping those stages to the grid service specification architectural elements and to the hosting environment, the grid services management system allows for dynamic deployment and undeployment of grid services, grid service self-undeployment capability, clear separation of responsibility for grid service life-cycle for simplifying grid service development, callable interfaces for life-cycle state transitions, among other advantages.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A system for providing life-cycle management of grid services, comprising:
at least one Open Grid Service Infrastructure (OGSI)-enabled hosting environment;
a grid services management system executing on said hosting environment;
wherein said grid services management system includes a service state and transition model, said service state and transition model defining life-cycle service states and transition states associated with a grid service.

2. The system of claim 1, further comprising an application programming interface operable for providing grid service access to built-in life-cycle functions.

3. The system of claim 2, wherein said at least one OGSI-enabled hosting environment provides a running instance of OSGI with a runtime for said grid service and a developer's programming environment.

4. The system of claim 1, further comprising an interface operable for notifying a grid service of a state transition being imposed upon said grid service by said OGSI-enabled hosting environment.

5. The system of claim 4, wherein a service state in which a grid service is being transitioned from is passed to said grid service in a call.

6. The system of claim 1 further comprising XML extensions of Grid Services Specification operable for supporting life-cycle management of said grid services.

7. The system of claim 1, wherein said life-cycle service states include:
deployed indicating a deployed service state;
deployed/started;
started;
started/registered; and
deployed/started/registered.

8. The system of claim 7, wherein a register state includes a grid service addition to a registry service, said registry service implementing a service group portType.

9. The system of claim 1, wherein said transition states include:
a static deploy transition indicating a transition between a start terminal and initiation of a static grid service deployment.

10. The system of claim 1, wherein said transition states include:
a dynamic deploy transition indicating a transition between an initiation point and initiation of a dynamic grid service deployment.

11. The system of claim 1, wherein said transition states include:
a start transition indicating a transition between a deployed service state and deployed/service state, said start transition operable for indicating when a grid service has become operational.

12. The system of claim 1, wherein said transition states include:
a stop transition indicating a transition between deployed/started service state and a deployed service state, said stop transition operable for indicating when a deployed grid service stops operating.

13. The system of claim 1, wherein said transition states include:
a register transition indicating a transition between a deployed/started service state and a deployed/started/registered service state, said register transition operable for indicating when grid service is registered in a local OGSI-instance registry.

14. The system of claim 1, wherein said transition states include:
an unregister transition indicating a transition between a deployed/started/registered service state and a deployed/started service state, said unregistered transition operable for indicating a grid service is unregistered.

15. The system of claim 1, wherein said transition states include:
a deploy transition indicating a transition between at least one of:
a started service and a deployed/started service state; and
a started/registered service state and a deployed/started/registered service state; wherein said deploy transition operable for indicating when a running grid service instance determines said grid service will be deployed.

16. The system of claim 1, wherein said transition states include:
an undeploy transition indicating a transition between at least one of:
a deployed/started/registered service state and a started/registered service state; and
a deployed/started service state and a started service state;
wherein said undeploy transition indicates a deployed grid service is undeployed;

17. The system of claim 1, wherein said transition states include:
a destroy transition indicating a transition between at least one of:
a started service state and a terminal point, wherein said destroy transition indicates an operational grid service instance is destroyed; and
a deployed service state and a terminal point indicating a transition where a deployed grid service is destroyed.

18. The system of claim 1, wherein said transition states include:
a factory createService transition indicating a transition between an initiation point and a started service state and indicates when a grid service becomes operational.

19. A method for managing a grid service life-cycle, comprising:
defining states in a grid service life-cycle;
defining transitions between said states in said grid service life-cycle;
mapping said states to architectural standards provided in a grid service specification; and
mapping said transitions between said states to architectural standards provided in said grid service specification.

20. The method of claim 19, wherein said grid service specification comprises Open Grid Service Infrastructure (OGSI).

21. The method of claim 19, wherein said states in said grid service life-cycle include:
deployed state indicating a deployed service state;
deployed/started state;
started state;
started/registered state; and
deployed/started/registered state.

22. The method of claim 21, further comprising:
notifying a grid service of a state transition occurrence being imposed on said grid service by a hosting environment;
wherein said notifying said grid service of a state transition includes identifying a state being transitioned from by said hosting environment.

23. The method of claim 21, wherein a register state includes a grid service addition to a registry service, said registry service implementing a service group portType.

24. The method of claim 19, wherein said transitions between said states include:
a static deploy transition indicating a transition between a start terminal and initiation of a static grid service deployment.

25. The method of claim 19, wherein said transitions between said states include:
a dynamic deploy transition indicating a transition between an initiation point and initiation of a dynamic grid service deployment.

26. The method of claim 19, wherein said transitions between said states include:
a start transition indicating a transition between a deployed service state and deployed/service state, said start transition operable for indicating when a grid service has become operational.

27. The method of claim 19, wherein said transitions between said states include:
a stop transition indicating a transition between deployed/started service state and a deployed service state, said stop transition operable for indicating when a deployed grid service stops operating.

28. The method of claim 19, wherein said transitions between said states include:
a register transition indicating a transition between a deployed/started service state and a deployed/started/registered service state, said register transition operable for indicating when grid service is registered in a local OGSI-instance registry.

29. The method of claim 19, wherein said transitions between said states include:
an unregister transition indicating a transition between a deployed/started/registered service state and a deployed/started service state, said unregistered transition operable for indicating a grid service is unregistered.

30. The method of claim 19, wherein said transitions between said states include:
a deploy transition indicating a transition between at least one of:
a started service and a deployed/started service state; and
a started/registered service state and a deployed/started/registered service state; wherein said deploy transition operable for indicating when a running grid service instance determines said grid service will be deployed.

31. The method of claim 19, wherein said transitions between said states include:
an undeploy transition indicating a transition between at least one of:
a deployed/started/registered service state and a started/registered service state; and
a deployed/started service state and a started service state;
wherein said undeploy transition indicates a deployed grid service is undeployed;

32. The method of claim 19, wherein said transitions between said states include:
a destroy transition indicating a transition between at least one of:
a started service state and a terminal point, wherein said destroy transition indicates an operational grid service instance is destroyed; and
a deployed service state and a terminal point indicating a transition where a deployed grid service is destroyed.

33. The method of claim 19, wherein said transitions between said states include:
a factory createService transition indicating a transition between an initiation point and a started service state and indicates when a grid service becomes operational.

34. A storage medium encoded with machine-readable computer program code for managing a grid service life-cycle, the storage medium including instructions for causing a computer to implement a method, comprising:
defining states in a grid service life-cycle;
defining transitions between said states in said grid service life-cycle;
mapping said states to architectural standards provided in a grid service specification; and
mapping said transitions between said states to architectural standards provided in said grid service specification.

35. The storage medium of claim 34, wherein said grid service specification comprises Open Grid Service Infrastructure (OGSI).

36. The storage medium of claim 34, wherein said states in said grid service life-cycle include:
deployed state indicating a deployed service state;
deployed/started state;
started state;
started/registered state; and
deployed/started/registered state.

37. The storage medium of claim 34, further comprising instructions for causing said computer to implement:
notifying a grid service of a state transition occurrence being imposed on said grid service by a hosting environment;
wherein said notifying said grid service of a state transition includes identifying a state being transitioned from by said hosting environment.

38. The storage medium of claim 36, wherein a register state includes a grid service addition to a registry service, said registry service implementing a service group portType.

39. The storage medium of claim 34, wherein said transitions between said states include:
a static deploy transition indicating a transition between a start terminal and initiation of a static grid service deployment.

40. The storage medium of claim 34, wherein said transitions between said states include:
a dynamic deploy transition indicating a transition between an initiation point and initiation of a dynamic grid service deployment.

41. The storage medium of claim 34, wherein said transitions between said states include:
a start transition indicating a transition between a deployed service state and deployed/service state, said start transition operable for indicating when a grid service has become operational.

42. The storage medium of claim 34, wherein said transitions between said states include:
a stop transition indicating a transition between deployed/started service state and a deployed service state, said stop transition operable for indicating when a deployed grid service stops operating.

43. The storage medium of claim 34, wherein said transitions between said states include:
a register transition indicating a transition between a deployed/started service state and a deployed/started/registered service state, said register transition operable for indicating when grid service is registered in a local OGSI-instance registry.

44. The storage medium of claim 34, wherein said transitions between said states include:
an unregister transition indicating a transition between a deployed/started/registered service state and a deployed/started service state, said unregistered transition operable for indicating a grid service is unregistered.

45. The storage medium of claim 34, wherein said transitions between said states include:
a deploy transition indicating a transition between at least one of:
a started service and a deployed/started service state; and
a started/registered service state and a deployed/started/registered service state; wherein said deploy transition operable for indicating when a running grid service instance determines said grid service will be deployed.

46. The storage medium of claim 34, wherein said transitions between said states include:
an undeploy transition indicating a transition between at least one of:
a deployed/started/registered service state and a started/registered service state; and
a deployed/started service state and a started service state;
wherein said undeploy transition indicates a deployed grid service is undeployed;

47. The storage medium of claim 34, wherein said transitions between said states include:
a destroy transition indicating a transition between at least one of:
a started service state and a terminal point, wherein said destroy transition indicates an operational grid service instance is destroyed; and
a deployed service state and a terminal point indicating a transition where a deployed grid service is destroyed.

48. The storage medium of claim 34, wherein said transitions between said states include:
a factory createService transition indicating a transition between an initiation point and a started service state and indicates when a grid service becomes operational.
